(19) United States
(12) Patent Application Publication
(10) Pub. No.: US 2014/0251902 A1
(43) Pub. Date: Sep. 11, 2014

(54) METHOD AND DEVICE FOR THERMAL BIOLOGICAL BREAKDOWN AND DEWATERING OF BIOMASS

(71) Applicant: Cambi Technology AS, Asker (NO)

(72) Inventors: Odd Egil SOLHEIM, Hvalstad (NO); Pål Jahre Nilsen, Bodalen (NO)

(73) Assignee: Cambi Technology AS, Asker (NO)

(21) Appl. No.: 14/197,899

(22) Filed: Mar. 5, 2014

(30) Foreign Application Priority Data
Mar. 6, 2013 (NO) 20130339

(51) Int. Cl. C02F 11/18; C02F 11/12

(52) U.S. Cl. CPC C02F 11/18; C02F 11/127
USPC 210/609; 210/177; 210/178

(57) ABSTRACT

A method is described for thermal biological breakdown and dewatering of biomass, which is characterised in that it comprises the following steps:
lead the biological residue material (8) from a digesting tank (6) to a dewatering device (9) and dewater the material to typically 15-25% dry matter,
lead the dewatered material (10) to a device (12) and carry out a thermal hydrolysis at typically 145-170° C. for typically 10-40 minutes,
subject the hydrolysed biomass (14) to a quick pressure reduction that results in a steam explosion in the biomass,
dewater the thermally hydrolysed and steam exploded hot biomass (14), at typically 85-105° C. in a closed dewatering unit (16), typically a centrifuge, to typically 35-60% dry matter,
cool the dewatered biomass (18) in a cooler (19), preferably an air-cooler and dewater the biomass further by evaporation to typically 40-75% dry matter,
lead the liquid phase (17) from the dewatering unit (16), which contains considerable amounts of hydrolysed organic matter and heat upstream of the digesting tank (6) for increased production of biogas.
   Also described is a device to carry out the method.

The present invention relates to a method for thermal biological treatment of organic material from a dewatered biological residue. The aims of the invention are to optimise dewatering of a biological residue and also to ensure a bio-residue free of pathogens (Class A) with a simultaneous elimination of bad odours. With this method a considerable part of the residual energy in the biological residue is recovered and the method is essentially more energy efficient than previously known methods.

### BACKGROUND TO THE INVENTION

Thermal hydrolysis is a known method to break down biomass so that it is better suited to biological processes for energy conversion such as, for example, degradation to biomass. WO96/09882 (Solheim) describes an energy efficient process for hydrolysis of biomass with an associated cooling down before the biomass is sent to a digesting tank for production of biomass. By hydrolysing the biomass before the digesting, one achieves a larger extent of digestion, more biomass and better dewatering compared to digesting without thermal pre-treatment. The method can ensure good sanitation of the biological residue as all the biomass has been treated at typically 160° C. for more than 20 minutes. The final dewatering of the biological residue after the digesting tank is still limited because the biomass that is produced in the digesting tank is not hydrolysed. In this biomass, the bacteria that produce the biogas typically make up 5-15% of the total biomass. These bacteria are good at retaining water and thereby represent a problem for the dewatering of the biomass. The present invention solves this and improves the final dewatering by hydrolysing all the biomass that comes out of the digesting tank.

U.S. Pat. No. 2,131,711 (Porteous) describes a method for thermal hydrolysis of sludge/biomass from the drainage system on boats. By heating the sludge up to 150° C. part of the sludge is hydrolysed and dewatering is simplified. Porteous does not describe any biological breakdown of the biomass in a digesting tank, nor a steam explosion that breaks the biomass down into small particles and releases flash steam that contains the foul smelling gases. The Porteous process was used on a number of land based treatment plants, but experienced great problems with odour. All such installations are now closed because of the smell. The present invention carries out the hydrolysis on the degraded biomass as opposed to the Porteous process and has three processing steps for the handling of the odour problem. This is one of the main aims of the invention.

None of these previously known methods hydrolyse/steam explode after the digesting tank for direct dewatering so that the biomass that is produced in the digesting tank by biogas production is also treated.

WO 03043939 A2 and WO 2008/115777 A1 (Lee) describes a method where one hydrolyses the biomass and dewaters it. The dry fraction goes to composting or combustion, while the liquid phase is mixed with other organic liquid streams and is led to a digesting tank. This gives no hydrolysis of the biomass that is produced in the digesting tank and does not lead to a sterilised biological residue from the digesting tank.

WO 2009/16082 A2 (Schwarz) describes two possible configurations of digesting and thermal hydrolysis. In the first alternative the hydrolysis process is placed between two digesting tanks. The hydrolysis is carried out on the dry fraction after dewatering. The hydrolysed dry fraction is sent to a new digesting tank while the liquid phase goes partly directly to final storage or to the second digesting tank. The biomass that is produced in the second digesting tank is mixed with the biological residue that comes out of the digesting tank and reduces the dewatering potential of the biological residue. In the second alternative that is described by Schwarz only one digesting tank is used, in which dewatering is carried out on a biological residue from the digesting tank whereupon the whole or parts of the dry fraction are thermally hydrolysed and recycled to the digesting tank. The rest of the dry fraction and the liquid phase are sent to final storage. In this alternative there is no sterilisation of the biological residue and the dewatering takes place without thermal hydrolysis of the biomass that is produced in the digesting tank. The handling of odours is not described.

U.S. 2012/0094363 A1 and WO 2010/100281 A1 (Nawawi-Lansade) describes as Schwarz two alternatives for the position of the thermal hydrolysis step. The first alternative places the thermal hydrolysis step between two digesting tanks. The final dewatering of the biological residue is thereby carried out without hydrolysis of the biomass that is produced in the second digesting tank. The present invention operates with only one digesting tank and hydrolyses all the biomass that comes from the digesting tank and thereby achieves a very high degree of dewatering. The second alternative of Nawawi-Lansade is similar to Schwarz in that the thermal hydrolysis takes place after the dewatering from a digesting tank. The liquid phase and parts of the dewatered biological residue are sent to final storage while the rest of the dewatered biological residue is recycled to the digesting tank. The liquid phase from the dewatering after the digesting tank is sent back to the treatment plant. Thereby, Nawawi-Lansade does not hydrolyse the biomass that is produced in the digesting tank before it is sent out of the plant. The dewatered, degraded biological residue that is sent to final storage is not sterilised either.

The Aim of the Invention

The aim of the invention is to optimise dewatering of the biological residue from the digesting tank to minimise transport of the dewatered biological residue, and also to increase the energy yield from the biomass that is led to the digesting tank. The present invention improves the final dewatering by hydrolysing all the biomass that comes from the digesting tank (10), also the biomasses of acid-forming and methane-forming bacteria that are produced in the digesting tank. The last final dewatering takes place at a high temperature for optimal result (16).

The present invention uses thermal hydrolysis and steam explosion from a standard first final dewatering unit. The biomass that is hydrolysed/steam exploded has a high dry matter content. This gives a considerably more energy efficient process than previously known methods with thermal hydrolysis. With this method a considerable fraction of the residual energy in the biological residue is recovered as biogas by sending the rejected water from the last final dewatering of thermally hydrolysed biological residue back to the digesting tank (17).

All the dewatered biological residue that goes to final storage is sterilised and free of pathogens.

Previous attempts with hydrolysis of sludge before dewatering created great problems with odour (the Porteous process).

According to the present invention the odour problem is eliminated via three processing steps:
1. The biological residue that is hydrolysed also goes through a steam explosion and a pressure reduction that releases strongly smelling gases such as sulphur containing thiols (mercaptans) and organic acids. These gases are recycled to an upstream digesting tank where they are broken down biologically and the odour eliminated.
2. After dewatering in a closed processing step the hot biological residue with a high dry matter content will be cooled down in a closed drier. Here, the cold air from the surroundings will be blown across the biological residue so that water evaporates and heats up the air and saturates this with water vapour. Most of the residual, volatile odour compounds in the biological residue will go with the cooling air out of the drier.
3. This air is sent to cleaning in a scrubber or a biofilter, it can be burned in a burner of a steam boiler or it can be used as charged air for a biogas engine so that the odour is eliminated.
   The cooled, aerated biological residue is thereby stabilised and has a reduced odour.

If the cooling air from the belt drier is treated in a scrubber, it is appropriate to use rejected water from the pre-dewatering before the thermal hydrolysis for this. This water is very alkaline and easily captures the volatile organic acids. The odour is thereby eliminated effectively.

These aims are reached with a method for thermal biological breakdown and dewatering of biomass, characterised in that the method comprises the following steps:
lead the biological residue material from a digesting tank to a dewatering device and dewater the material to a typical 15-25% dry matter,
lead the dewatered material to a device and carry out a thermal hydrolysis at a typical 145-170° C. for typically 10-40 minutes,
subject the hydrolysed biomass to a quick pressure reduction that results in a steam explosion in the biomass,
dewater the thermally hydrolysed and steam exploded hot biomass, typically at 85-105° C. in a closed dewatering unit, typically a centrifuge, to typically 35-60% dry matter,
cool the dewatered biomass in a cooler, preferably an air-cooler and dewater the biomass further by evaporation to typically 40-75% dry matter,
lead the liquid phase from the dewatering unit, which contains considerable amounts of hydrolysed organic matter upstream of the digesting tank for increased production of biogas.

Present invention also relates to a device for thermal biological breakdown and dewatering of biomass, said device is characterised in that it contains in sequence:
a digesting tank for degradation of the biomass,
a first dewatering device,
a device for thermal hydrolysis and pressure reduction/steam explosion,
a second dewatering device, and
a cooler.

Further favourable embodiments are given in the characteristic part of the dependent claims.

### FIGURE DESCRIPTION

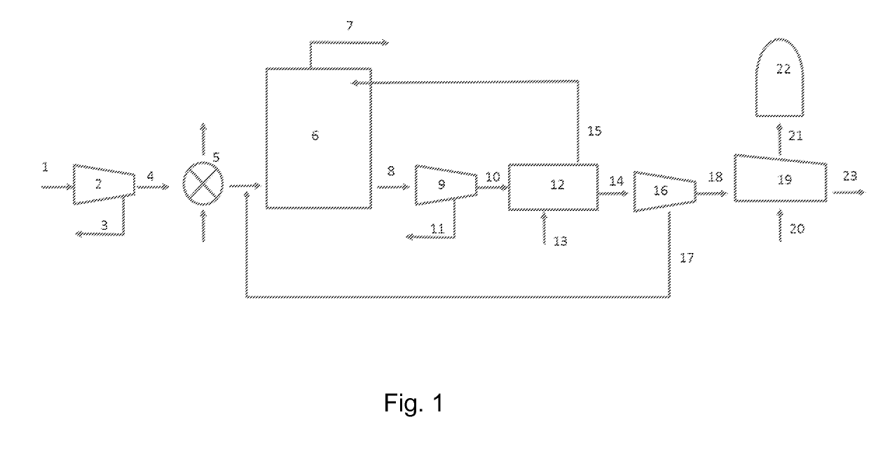

The invention will be described in more detail in the following text with the help of an embodiment example with reference to the enclosed FIG. 1, which schematically shows an embodiment form of the method according to the invention.

### DETAILED DESCRIPTION OF THE INVENTION

An embodiment of the method according to the invention is shown in FIG. 1, where the biomass (1) from, for example, a waste water treatment plant is thickened in a pre-dewatering unit (2) to typically 4-8% dry matter (DM). The rejected water (3) is typically sent back to the treatment plant. The dewatered biomass (4) is heated in a heat exchanger (5) and is sent to a digesting tank (6). Here, the biomass is broken down by methane-forming bacteria and produces biogas (7). The degraded biomass, including the methane forming bacteria (8) is sent to a first final dewatering (9). The rejected water (11) is typically sent back to the treatment plant while the dewatered biomass (10) with a typical 15-25% DM is sent to a hydrolysis and steam explosion unit (12). Here, the biomass is heated up under pressure to typically 145-175° C. by the injection of steam (13) at a typical pressure of 7-15 bar in a hydrolysis reactor. After heating up, the biomass is held at a desired temperature for typically 20-60 minutes to ensure sterilisation and hydrolysis. After this the biomass is quickly transferred to a depressurising tank so that a steam explosion takes place in the biomass. With this the biomass is ripped apart and the dewatering characteristics are improved. At the same time sulphur containing process gases and volatile organic acids are released. These gases are collected and sent back to the digesting tank through a process gas pipe (15) for biological breakdown and elimination of odours. The hydrolysed and sterilised biomass (14) is sent to a closed second final dewatering unit (16) at a typical 85-105° C. Dewatering at a high temperature ensures a good result, typically 35-60% DM. The reject water (17) contains the hydrolysed biomass typically 10-30% of the organic matter from the first final dewatering (10). This is sent back to the inlet of the digesting tank for degradation and gives an increase in biogas production of typically 5-20%. The heat in this reject water (17) is recovered and leads to a reduction of the heating requirement in the upstream heat exchanger (5) of typically 10-40%. The dewatered biological residue from the second final dewatering (18) is warm, typically 80-105° C., and is sent to an air cooler (19) for cooling down and stabilising. Cold and preferably dry air from the surroundings (20) at a typical relative humidity of 10-50% and at 10-40° C. is blown across the warm biological residual. The air is saturated with water vapour from the biological residual and cools the biological residual. At the same time the dry matter content of the biological residue increases with typically 5-15%.

The remains of the volatile, sulphur-containing process gases and organic acids follow the cooling air (21) out of the air cooler. This air mixture can be odourous and must be treated in a separate unit (22). This can be carried out with a liquid scrubber where preferably alkaline reject water (11) can be used for optimal is capture of organic acids. Or the air mixture can be burned in an engine or a burner of a steam boiler.

The cooled biological residue (23) is sent to final storage. This is now suited to be burnt as the dry matter content is high, typically 40-75% or it can be used as biological fertilizer in agriculture as it has been sterilized.

### EXAMPLE

Dewatered biological residue with a dry matter content of 28% from a thermophilic digesting tank with 60% conversion of organic material to biogas from a full scale treatment plant, was thermally hydrolysed at 165° C. and steam exploded in a test rig. 20-30% of the organic matter that was in the biological residue was hydrolysed and followed the liquid phase in the subsequent dewatering. The dewatering of the thermally hydrolysed and steam exploded biological residue took place in a centrifuge without the use of polymers and ended up at 45-55% dry matter. The liquid phase from the dewatering was digested in bottle tests where 83-96% of the hydrolysed organic matter was converted to biogas.

If one uses these test results as a premise for the full scale plant at which the test was carried out, this will result in an 11-18% increase in biogas production and 44-55% reduction in the amount of dewatered biological residue. This represents considerable economic advantages for the plant. The increased biogas production due to the present invention is sufficient to provide steam for the thermal hydrolysis/steam explosion (12), thus, the process is a net “Zero Energy Dryer”.

1. A method for thermal biological breakdown and dewatering of biomass, the method comprising:
leading the biological residue material from a digesting tank to a dewatering device and dewatering the material to a typical 15-25% dry matter;
leading the dewatered material to a device and carrying out a thermal hydrolysis at a typical 145-170° C. for typically 10-40 minutes;
subjecting the hydrolysed biomass to a quick pressure reduction that results in a steam explosion in the biomass;
dewatering the thermally hydrolysed and steam exploded hot biomass, typically at 85-105° C. in a closed dewatering unit, typically a centrifuge, to typically 35-60% dry matter;
cooling the dewatered biomass in a cooler, preferably an air-cooler and dewatering the biomass further by evaporation to typically 40-75% dry matter; and
leading the liquid phase from the dewatering unit, which contains considerable amounts of hydrolysed organic matter upstream of the digesting tank for increased production of biogas.

2. The method according to claim 1, wherein foul smelling process gasses formed in the pressure reduction and steam explosion step are captured and sent further for biological breakdown and odour elimination in a digesting tank.

3. The method according to claim 1, wherein the moist cooling air containing some process gases from the air cooler is led to combustion or washing in a scrubber or to breakdown in a biofilter.

4. A device for thermal biological breakdown and dewatering of biomass, the device comprising:
A digesting tank for degradation of the biomass;
a first dewatering device;
a device for thermal hydrolysis and pressure reduction/steam explosion;
a second dewatering device; and
a cooler.

5. The device according to claim 4, wherein the device for thermal hydrolysis is connected with the digesting tank for the transfer of gases formed in the device to the digesting tank.

6. The device according to claim 4, wherein the second dewatering device is connected to the digesting tank for the recycling of the liquid phase from the second dewatering device to the digesting tank.

7. The device according to claim 4, wherein the second dewatering device is a centrifuge.

8. The device according to claim 4, wherein the cooler is an air cooler.
